(19) United States
(12) Patent Application Publication
(10) Pub. No.: US 2003/0050819 A1
(43) Pub. Date: Mar. 13, 2003

(54) Computer-implemented, integrated system and method for managing global logistics

(76) Inventors: Mary Jo Koenigbauer, Ira Township, MI (US); Marilyn Maddox, Birmingham, MI (US); Pamela Stec, Franklin, MI (US)

Correspondence Address: BROOKS & KUSHMAN P.C./FGTI, 1000 TOWN CENTER, 22ND FLOOR, SOUTHFIELD, MI, 48075, US

(21) Appl. No.: 10/232,242

(22) Filed: Aug. 30, 2002

Related U.S. Application Data
(60) Provisional application No. 60/316,769, filed on Aug. 31, 2001.

(51) Int. Cl. G06F 19/00

(52) U.S. Cl. 705/8; 700/95; 700/99

(57) ABSTRACT

One preferred computer-implemented system embodiment of the present invention includes a computer system for managing logistics for manufacturing and assembly supply chains comprised of a plurality of suppliers, a plurality of plants, a plurality of parts, and a plurality of transportation modes, the computer-implemented system comprising at least one computer configured to: receive logistics information; store logistics information in a data warehouse contained on the at least one computer; and apply logic to at least a portion of the logistics information stored in the data warehouse to obtain at least one logistics information grouping relied upon by logistics users to manage at least one logistics initiative. Another aspect of the present invention is a computer-implemented system for determining an inbound logistics plan.

### CROSS-REFERENCE TO RELATED APPLICATIONS

This application claims the benefit of U.S. Provisional Application Serial No. 60/316,769, filed Aug. 31, 2001, entitled “Global Logistics Management System”.

### BACKGROUND OF THE INVENTION

1. Field of the Invention

At least one aspect of the present invention generally relates to a computer-implemented, integrated system for managing global logistics.

2. Background Art

Today's global economy relies on the rapidly growing field of logistics to plan, implement, and control the efficient flow and storage of goods and services from start location(s) to consumption point(s) to conform to business requirements.

In light of this increased reliance, companies have developed logistics software and offered logistics services to meet the logistics needs of businesses, especially those operating in the global economic environment. For example, i2 Technologies of Dallas, Tex. offers a web-based Transportation logistics software suite that enables businesses to procure, plan, execute and monitor freight across multiple modes, borders and enterprises. More information regarding i2's Transportation logistics solution is available at http://www.i2.com. International Business Machines Corporation (“IBM Corp.”) offers a variety of logistics research labs and services, including consulting, touching on many theoretical logistics issues.

Logistics solutions have also been the subject of issued patents and published patent applications. U.S. patent application Ser. No. 2002/0065738, entitled “Transport Logistics System and Methods”, relates to logistics systems and methods for the transportation of goods. U.S. patent application Ser. No. 2002/0019761, entitled “Supply Chain Architecture”, relates to a supply chain network with limited centralized operation functionality. U.S. Pat. No. 5,787,283, entitled “Framework for Manufacturing Logistics Decision Support”, and assigned to IBM Corp., relates to a tool and methodology for developing unique software application programs from a framework of reusable software parts for solving complex manufacturing logistics problems.

Although these logistics solutions may cover many logistics planning and implementation issues, they do not offer a complete logistics system that integrates planning, implementation, procurement and payment for managing logistics for manufacturing and assembly supply chains comprised of a plurality of suppliers, a plurality of plants, a plurality of parts, and a plurality of transportation modes.

One of the disadvantages of the prior art logistics management systems is that important information is spread throughout manufacturer modules and databases. For example, the department responsible for bill payment has its own database and the supply chain design department maintains its own database. The information has not been integrated. With the non-automated and non-integrated system, procurement modules are commonly not linked to production purchasing information. For example, if a supplier or source is changed, the procurement module is not informed until the transportation provider arrived at a supplier only to be informed that the manufacturer did not ship from that site.

None of the logistics solutions available in the market today present a complete, global and fully integrated logistics system that integrates supply chain design, procurement, bill payment, cost control, budgeting, etc. Consequently, companies are forced to implement a patchwork combination of stand-alone software products and manual entry systems to provide integrated solutions. For example, in order to determine the appropriate method of shipment, a logistics system implemented by Ford Motor Company (“FMC”) manually evaluates factors such as shipping methods, shipping costs, unit price, size, weight, quality of shipment, geography, plant demands and predictability of shipment. The manual evaluation process often leads to inconsistencies and inefficiencies in the evaluation process. As another example, part orders are often based on non-integrated and outdated information about demand and often result in excess. The extra quantities are stored as inventory until needed by the plant on the assembly line. Storing parts can be expensive, require excessive floor space and create a situation where the part is difficult to locate once in storage.

The prior art logistics systems also lack functionality for a fully integrated and global inbound logistics solution. Companies with multiple manufacturing and assembly supply chains expend tremendous resources on inbound logistics. Consequently, an inbound logistics system that can deliver cost savings could save companies millions of dollars. Inbound logistics, the science dealing with the details of procurement and transportation of material into a facility, for large manufacturing organizations, such as an automobile manufacturer are extremely complex and very costly.

Inbound logistics networks in large companies, such as the automotive manufacturing industry, consist of multiple tiers. Tier 1 suppliers supply assembly plants with various parts. These include a manufacturer's own manufacturing plants, such as stamping plants or powertrain plants, as well as external suppliers. The Tier 1 suppliers are supplied by Tier 2 suppliers, who in turn were supplied by Tier 3 suppliers.

The inbound logistics supply chain network for a large manufacturing facility such as FMC's North American assembly plants consists of: 50 assembly plants, 420 suppliers, 3000 shipping points, 1600 shipping points to assembly plants, and 3000 parts per vehicle.

Adding to the complexity of the inbound logistics network is the increased use of returnable containers, as opposed to expendable containers, used to ship parts or assemblies from one supplier to another supplier or to the assembly plants. Use of returnable containers has significant impact on the inbound logistics in terms of cost and complexity of management.

What is needed is a computer-implemented, integrated logistics system that provides global logistics management, including procurement, logistics planning and execution of logistics plans, payment and metrics reporting. Moreover, a logistics system is needed that provides inbound logistics tactical planning.

### SUMMARY OF THE INVENTION

One aspect of the present invention is a computer-implemented, integrated logistics tool for providing useful logistics information to logistics users for managing logistics initiatives. Another aspect of the present invention is a computer-implemented system for managing logistics initiatives on an automated level that does not require the manual input of information into logistics computer programs. Another aspect of the present invention is a logistics management tool that is integrated across various logistics categories, such as design and procurement.

The systems and methods of the present invention can evaluate factors for both the inbound transport of parts and the outbound transport of a complex manufactured product such as an automobile. By way of example, shipment costs as related to other factors such as speed can be considered. For instance, the present invention can consider that shipment by rail is usually cheaper than methods such as air shipment. However, rail shipment has some disadvantages such as shaking or jostling of products during transport and unpredictable delivery time. In addition, if a particular plant needs a small part quickly or the part is extremely expensive, air transport may be the best option, even though it is more expensive. Shipment by truck is generally more dependable than rail, and some trucks even have special equipment designed for special types of parts used by the manufacturer. Thus, this would be the preferred method. When shipping overseas, the system must take into account geography and distance.

One advantage of the present invention is improved synchronized material flow that is economical and reduces the need for excessive inventory. Inventory control is a critical element in the speed or delay of a final manufactured product. For example, if the manufacturer does not have a part and it takes a day to ship, valuable time is lost. Thus, if the manufacturer requires a part on an assembly line, the present invention can determine how the part will arrive at the assembly line, when it will arrive and in what quantity.

Another advantage of the present invention is accurate payment of bills and determination of liability.

The present invention can make compromises with respect to inventory. For example, with inbound parts, the quickest method to ship a part is by air. As stated above, air delivery would insure a quick delivery and low inventory but is expensive. As a result, the system may compromise by keeping more of the part in inventory to save costs. The inventory would also provide protection in situations like when the demand changes and it may take significant time to ship parts to the plant.

The present invention can also determine options to reduce lead time required to ship parts to a plant. The resultant reduction of transient time and distance between the part and the plant will reduce the amount of inventory required because the decreased time and distance reduces the risk of occurrences that could disrupt the shipment. For example, suppose more inventory is required from suppliers farthest from the plant. The manufacturer may ship five days worth of material instead of one day from suppliers who reside a great distance from the plant. The increased inventory protects against any number of things that could go wrong, like bad weather, that would result in delayed delivery and subsequently interrupted production.

An advantage of the present invention is to have improved predictability, the ability to anticipate unforeseen events, the ability to have efficient changes and the ability to provide alternative methods to ship the parts or the final product.

As a budgeting component, the present invention can produce a budget and product program for the final product. For example, if a certain automobile is to be produced 30 months in the future, the present invention can predict the cost of transporting parts for that vehicle. For instance, with a new model of a vehicle, the present invention can evaluate whether the costs will increase for the new model. The product program must also include the methods of shipment anticipated for the new vehicle. The logistic system that is finally developed for a new or revised product can include factors such as whether facilities have to be rented as a consolidation center and the arrangements for shipping.

One preferred computer-implemented system embodiment of the present invention includes a computer system for managing logistics for manufacturing and assembly supply chains comprised of a plurality of suppliers, a plurality of plants, a plurality of parts, and a plurality of transportation modes, the computer-implemented system comprising at least one computer configured to: receive logistics information; store logistics information in a data warehouse contained on the at least one computer; and apply logic to at least a portion of the logistics information stored in the data warehouse to obtain at least one logistics information grouping relied upon by logistics users to manage at least one logistics initiative.

A preferred computer-implemented method embodiment of the present invention includes a method for managing logistics for manufacturing and assembly supply chains comprised of receiving logistics information; storing logistics information in a data warehouse contained on at least one computer; and applying logic to at least a portion of the logistics information stored in the data warehouse to obtain at least one logistics information grouping relied upon by logistics users to manage at least one logistics initiative.

A preferred computer-implemented system for determining an inbound logistics plan of the present invention includes an at least one computer configured to: store a plurality of supplier/plant/part combinations (each supplier/plant/part combination having a plurality of transportation modes and frequencies for transporting material from the supplier to the plant), determine a preferred supplier/plant/part combination with a preferred transportation mode and frequency for each supplier/plant/part combination which delivers minimal costs for transporting material from the supplier to the plant (the transportation costs calculated based on the transportation mode, transportation frequency, inventory and container costs, and use the preferred supplier/plant/part combination with the preferred transportation mode and frequency as part of an inbound logistics plan to minimize inventory, material, and rack costs.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with accompanying drawings which:

FIG. 1 is a schematic diagram illustrating a preferred system for implementing the present invention;

FIG. 2 illustrates a preferred GUI for displaying an IML accrual overview report;

FIG. 3 illustrates a preferred GUI for displaying and entering information pertinent to an IML accrual overview detail report; and

FIG. 4 illustrates a preferred GUI for entering information for generating a customized accrual reconciliation report.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

One aspect of the present invention provides a computer-implemented, integrated system for managing global logistics for multiple manufacturing and assembly supply chains, each comprised of a plurality of suppliers, a plurality of plants, a plurality of parts, and a plurality of transportation modes. The computer-implemented, integrated system is comprised of at least one computer. The at least one computer is configured to: (1) receive logistics plan information, procurement information, operating information, and billing information; (2) store the logistics plan, procurement, operating and billing information in a data warehouse; and (3) apply logic to at least a portion of the information stored in the data warehouse to obtain logistics information grouping(s) relied upon by logistics users to manage logistics initiatives. It should be understood that logistics information (i.e., logistics plan, procurement, operating, and/or billing information) can be transmitted from a plurality of sources to be received by the at least one computer. It should also be understood that the data warehouse can transmit the received logistics information to numerous sources, i.e., client or server computers, with or without transforming the logistics information. Logistics users can include, but are not limited to, the controller's office, supply chain management, global logistics and internal material flow managers and analysts, and order fulfillment groups. It should be understood that internal material flow managers and analysts refer to individuals responsible for material flow inside the plant. Logistics initiatives can include, but are not limited to, bill payment, planning, procurement, operations, cost control, budgeting and accrual reconciliation.

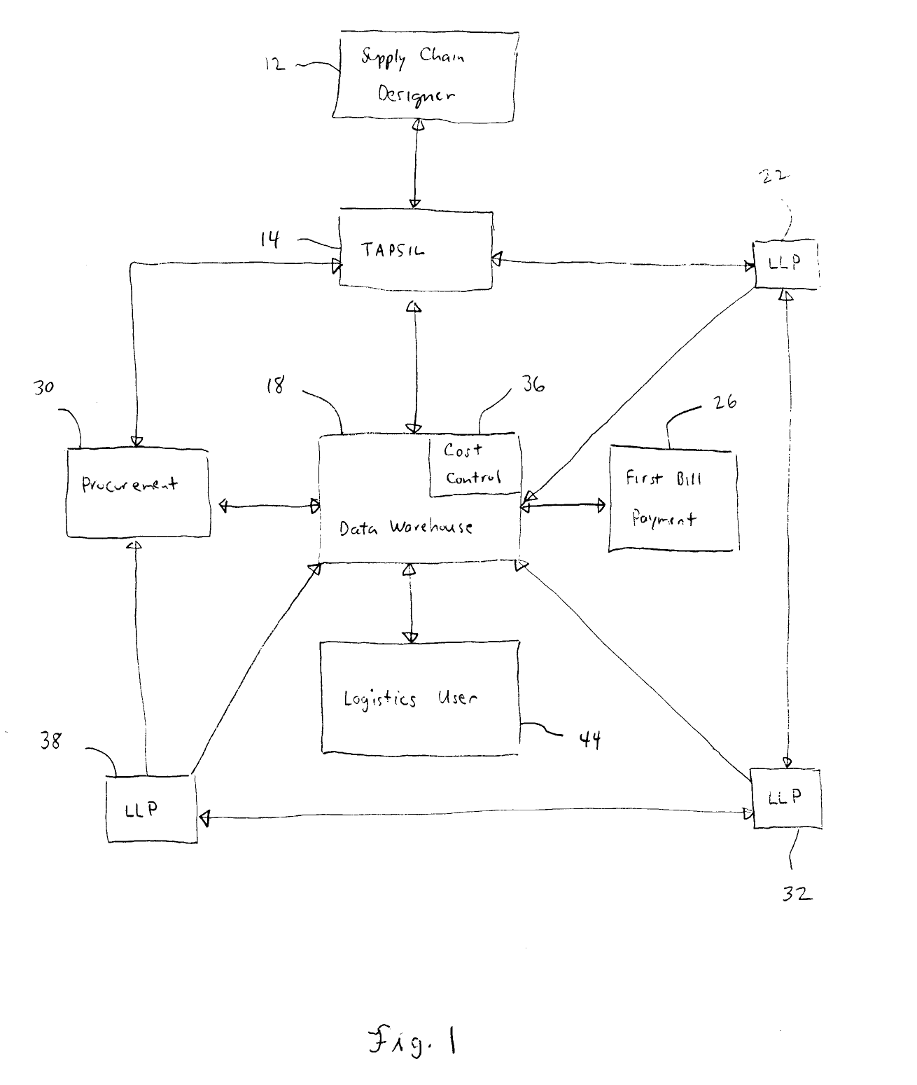

One preferred computer system for implementing the present invention is represented schematically in FIG. 1. The present invention can be implemented within a manufacturer or with additional partners operating within the logistics network called Lead Logistics Providers (LLPs). The LLPs may be used in both or either the inbound side and the outbound side. In the preferred computer system represented in FIG. 1, LLPs are utilized. Many of the blocks in FIG. 1 represent computer modules in the preferred computer-implemented, integrated logistics system. The following describes functionality and integration of the computer modules in accordance with the preferred computer system of the present invention.

Supply Chain Designer Module 12 establishes an infrastructure for an inbound logistics network and/or an outbound logistics network. The infrastructure can include the beginning point(s) and ending point(s) of a part in shipment. Thus, the Supply Chain Designer Module 12 establishes the start location(s), end location(s) and sourcing information. Additionally, the Supply Chain Designer Module 12 can determine whether any intermediate logistics facilities are necessary. These intermediate logistics facilities can be consolidation centers or cross-docks referred to as Origin Distribution Centers (“ODCs”)(described more fully below). At the ODCs, the parts are removed from one truck and placed on another truck. By way of example, if a single supplier ships parts on one truck to five plants, the truck from the supplier would unload at the ODC and the parts would be placed on five different trucks going to each plant. Supply Chain Designer Module 12 can determine whether the supply chain designs need to include cross dock or consolidation points and can transmit this information to TAPSIL Module 14.

Tactical Planning System for Inbound Logistics (“TAPSIL”) Module 14 can optimize inbound logistics to support a multi-tier supply chain. More particularly, TAPSIL Module 14 is a system decision support tool used to support a global logistics planning and control process, providing analysis for a logistics organization to support a manufacturing organization. The system includes optimization algorithms to determine optimal logistics plans balancing transportation, inventory, container and plant impact costs. Key TAPSIL Module 14 concepts include:

the ability to incorporate manufacturing constraints in a logistics planning applications;

simultaneously optimized frequency of delivery and transportation modes;

provides an executable plan, balancing delivery window times to provide implementable routing solutions at suppliers, cross docks and manufacturing facilities;

links planning and execution across all transportation modes;

models a closed loop flow of containers.

The first step conducted by the TAPSIL Module 14 is to determine the optimal transportation mode for each supplier/plant combination. Examples of transportation modes include, but are not limited to, rail, air, overland truck and ocean going ships. The use of rail can be limited to facilities within the necessary infrastructure and are rarely justified unless transport of high volume is involved. Air is justified for small parts with high value. Additionally, in the age of global organizations, overseas manufacturing facilities also feed parts to operations. In these cases, shipment may include several different modes.

Truck freight is the most prevalent form of shipment, and the majority of the truck shipments are direct full truck loads from a supplier to a plant. Under certain conditions, however, aggregating multiple suppliers shipments in some fashion may be more economical from a total cost point of view, even though the freight cost will increase. There are two ways of shipment aggregation: the milk run and the cross dock.

A milk run is where a truck makes a plurality of pickup stops and/or a plurality of delivery stops during a run. A cross dock is a system where several trucks bring parts to a “cross dock” facility (ODC) to be partially or fully unloaded and then reloaded with a different combination of parts for the trip to a plant. The milk run scheme is used to cover relatively small areas of pickup or delivery. As delivery area increases it loses its benefit. The cross dock scheme can be used to cover an extended area.

Milk runs should have relatively condensed locations for pickups and deliveries. A cross dock is used to support suppliers scattered in a wide area. The major feature of a cross dock operation is that multiple incoming trucks are planned and associated with multiple outgoing trucks. This synchronization allows high utilization of truck capacity and low-volume delivery for individual parts involved. By definition, the cross dock facility should be somewhere in the “midpoint” between suppliers and plants. In extreme cases, the incoming or outgoing truck could be serving milk run operations.

The Mode Selection or analysis strategy of the present invention is used to determine the optimal transportation mode for each supplier/plant combination. This strategy consists of two optimization functions: unconstrained and constrained. The unconstrained optimization assumes an unlimited amount of transportation resources for any mode. Therefore, the unconstrained mode selection strategy studies each case of supplier/plant independent of the other cases. The constrained optimization reflects the limited resources. Therefore, unconstrained optimization studies the entire set of supplier/plant cases described simultaneously. The constrained optimization requires output of the unconstrained optimization as its input. In either unconstrained or constrained optimizations the strategy tries to minimize the sum of all relevant cost elements affected by the mode selection:

Freight cost;

Fixed cost;

Variable cost;

Inventory carrying cost;

Pipeline inventory;

Plant inventory;

Plant impact cost;

Returnable container cost.

In fact, the decision variables that affect the total cost are not only mode but also frequency. The basic economics is there are two different types of cost elements that behave in opposite directions when changes are made in mode and frequency. The optimization is to balance these two groups of cost elements to minimize the total cost through careful study.

For each supplier or plant, the unconstrained optimization analyzes the total cost listed above as a function of mode and frequency. For a given mode, the unconstrained optimization consists of constructing the following type of total cost curve as a function of frequency and identifying the minimum cost and the associated frequency. The strategy will repeat the same construction for each feasible mode for the case. The optimum frequency may not fall where freight cost and inventory related costs are equal. This is because the inventory related cost contains a term that is more complex that a linearly inverse function.

There are other kinds of costs that are fixed for the tactical planning process. For example, the sourcing decisions are made outside this system, related costs such as customers are constant within this system. To account for the total cost, these fixed costs are captured.

The constrained optimization reflects the limited availability of transportation vehicles. One way of looking at the constrained problem is to summarize the results of the unconstrained optimization problem and to compare them against the availability by mode type. If the availability is more than needed for every mode type, the unconstrained solution is also optimal for the constrained problem. Otherwise, the unconstrained solution is infeasible to implement, and should therefore be modified. In this latter situation, the optimization considers all supplier/plant combinations simultaneously. The problem becomes an integer programming problem.

Another type of constrained optimization is capacity limitation of unloading at plants. This is an extension of the previous constrained model for transportation vehicles. Unloading capacities at the plants are captured.

Mixed modes are also considered, for example truck milk run to the cross dock and rail mode from the cross dock to the plant. Such finer details affect the solution and can be inputted after careful analysis.

The definition of mode can easily extend to include more details such as particular carriers and conveyances as needed. Another example is an inter-modal operation for a leg of a shipment. To support the necessary need, the proper table definitions may be entered.

The system allows introducing a new composite transportation strategy if all required cost elements and capacity constraints are determined.

Once the mode selection is complete, the user proceeds to the next strategies. The user proceeds directly to a Stowage Strategy for those combinations of a supplier/plant/part group with optimum modes of other than truck. The user must use the two strategies, Logistics Configuration and Rotation and Routing, in sequence to add more details beyond the mode for those with optimum mode of truck.

The Logistics Configuration Strategy illustrated covers only truck mode suppliers. The decision of which suppliers use the truck mode is made manually or automatically using a Mode Selection strategy. The Mode Selection strategy implicitly assumes point-to-point delivery. However, there are other operational schemes, for the truck mode, that allow reduction of total costs, such as milk run and cross dock. These are schemes to form a full load by involving a plurality of pickups/deliveries. The frequency obtained in the Mode Selection strategy for the truck mode is reevaluated reflecting these additional details.

Both schemes require intensive management effort. The cross dock scheme requires an especially high level of coordination among many involved trucks to synchronize their arrivals and departures. Any slippage by a truck will affect the efficiency of the overall operations. Both schemes will be more expensive in terms of delivery cost than a point-to-point scheme. Nevertheless, these schemes provide various cost savings over the entire organization since plants can carry lower inventory.

The Logistics Configuration strategy determines if a supplier should use, point-to-point, multiple pickups/deliveries, milk run, cross dock, or partial truck load.

The system considers a tradeoff between different transportation schemes. The objective function is to minimize total cost of transportation related costs and inventory related costs. The optimization process is divided into three steps:

1) group plants by proximity (this is done automatically by the system, subject to manual changes if necessary);

2) for each plant group, all associated suppliers will be clustered into groups, with each supplier group forming a closed loop (i.e., two suppliers that belong to two different supplier groups respectively will never be served by the same truck, but a supplier group may form a milk run to be served as frequently as needed; as a special case, a supplier group could contain only one supplier);

3) by overlaying solutions, the supplier groupings obtained in step 2, of different plant groups, cross dock opportunities is identified; this process may result in adjustments of previously defined supplier groups.

The main assumption is that every supplier within a supplier group has the same parts delivery frequency. This assumption is realized in the Rotation and Routing strategy.

As mentioned earlier, the partial truck load makes the modeling very complex because it requires that many locations be studied together. Even worse, it is not clear which locations should be studied together. In other words, the decisions for partial truck loads encompass not only frequency but also rotation, cross docking and routing.

The strategy determines an approximation of the freight cost factor for each supplier so to apply similar analysis as in the Mode Selection strategy for each supplier. One scheme is to derive a formula based on (1) the distance between plant and supplier and (2) density of other suppliers in the vicinity of a supplier.

It should be noted that the description of the model is simplistic. For example, a supplier may use more than one mode and certain parts may not be shipped together.

Summarizing, the main output of this strategy is:

Optimum scheme of shipments for truck;

Optimum frequency for each truck.

The basic elements of the strategy are:

Data Management unit includes:

1) Data Preparation (manual data input or data import from flat files),

2) Import the data from Mode Selection Strategy,

3) Editing capabilities,

4) Scenario Management tools.

This strategy could, for example, connect to the Ford's Data Warehouse (described more fully below) and retrieve input data in the future with necessary modifications to the system.

Data Pre-processing Unit includes:

1) System Configuration tools, and

2) Data Transformation functions.

This unit provides data validation and builds up a mathematical model based on the study objectives. Also it provides a means to incorporate a returnable container costs into the total cost.

Solver unit combines combinatorial optimization tools known in the prior art and available in products such as CPLEX with SynQuest proprietary solving tools.

Post-processing unit transforms the solution obtained by Solver into:

1) Logistics plan,

2) Delivery frequency,

3) Transportation scheme for truck mode,

4) Cost elements associated with the optimal plan.

Display unit:

1) Presents the results obtained using maps and graphs,

2) Generates reports,

3) Computes cost elements at the different level of aggregation (by part, by plant, by program, by supplier, etc.)

Utility unit provides the options to:

1) Save the solution,

2) Export the solution to the Rotation and Routing Strategy,

3) Change an input data and re-run the strategy,

4) “Freeze” a part of the solution and re-run the strategy,

5) Update data in the Data Warehouse.

The Rotation and Routing Strategy provides details of shipment schedules on both pickups (suppliers) and deliveries (plants) and covers only truck mode suppliers. For every truck shipment with frequency greater than once a week, this strategy will determine the days of the week of service. The objective is to minimize travel cost and satisfy docking capacity and unloading constraints by balancing the delivery load throughout the week.

The terminology “rotations” is defined as a set of days when the suppliers will be periodically served. Given a frequency, for example three times a week, there could be many different combinations of rotations. Therefore, assigning particular rotations to suppliers will determine a work load profile for a truck. The objective of this strategy is to smooth the load of work across a week to make the eventual plan operationally feasible for all parties, including suppliers, plants, and carriers.

The rotation part of the strategy will generate the shipment requirements and the routing part will generate the shipment schedule. The schedule includes shipment quantities, date and time, and stop sequences. The strategy will generate routes to serve suppliers defined as partial truckloads. The optimization will be done for each day of the week covering the entire set of suppliers and plants.

Algorithms can be developed to optimize routing problems. Depending on the need, proper algorithm(s) will be modified and selected. The total distance/time of travel is minimized. The TAPSIL Module 14 strategy considers all pertinent constraints such as:

Compatibility of parts and packaging

Multiple pickup/delivery

Vehicle capacity

Time windows

Loading/unloading time

Loading/unloading capacity

Multiple day driving

Driver working hours

Special attention is payed to determining the best method to compute distance between suppliers and plants. It should be noted that the best method for this project does not mean the most accurate. Methods range from simple formulas to sophisticated algorithms based on computational geometry. The last resort is to purchase distance data among zip codes, if the other methods fail to provide the proper level of accuracy.

The strategy considers dock specific loading and unloading capability in creating an optimal rotation and routing plan. A delivery dock optimization option can determine the optimum delivery dock plan at the plant to minimize in-plant movement costs subject to the unloading capacity of each dock. Each day, a plant can receive many trucks. A part inside a truck will have a cost of in-plant movement or plant impact cost assigned to it depending on the dock which it may go through. Then, an aggregated plant impact cost can be computed for each truck arriving at a dock for a day. The optimization problem is assigning each truck to a dock to minimize the total in-plant movement cost for a day while satisfying each dock's overall unloading capacity. Once an optimum dock is selected, the selected dock will be appended to the routing solution.

The strategy provides interactive editing facilities for the user to override the system-generated solution. It also provides the capability to lock part of the solution and re-optimize the rest.

Summarizing the strategy provides: Optimal group suppliers for each truck; Optimal sequence of stops on each route; and Detailed shipment schedules.

Optimization of Returnable Container Assignment Strategy is an extension of the Logistics Configuration strategy with a sensitivity analysis capability regarding returnable container related costs. This analysis only covers truck mode suppliers.

The reverse flow of returnable containers is included in the model in a one-for-one basis for the milk run. If a container load is picked up from a supplier, an empty returnable container is returned to the supplier. If a container load is delivered to a plant, an empty container is picked up from the plant. This applies only to the partial loads of pickup/delivery. Because the empty containers must be delivered to each supplier in a milk run, the user provides the proper loading/unloading time data to reflect more complex operations, such as relocating containers within a truck.

For all full truck loads (direct truck shipment), with or without containers, the cost of reverse flow of returnable containers is computed by applying space shrinkage factors after a product is unloaded and added to the total cost. It reflects the fact that the empty containers consume less volume than loaded containers. The one-to-one requirement for the reverse flow of returnable containers may also be loosened for the direct truck shipments.

The strategy is able to execute multiple optimizations in one batch by changing returnable container related costs systematically across all returnable containers and compile the results in a meaningful way to show the sensitivity of the frequency solution.

The returnable containers issue is addressed differently by the system depending on the amount and fidelity of input data. The number of returnable containers is modeled as a variable cost contributed to the total cost. When a purchasing decision is made, the number of returnable containers is modeled as constraints instead of output variables tied to the frequency without limitations. In this case, the allocation of limited returnable containers to each supplier is an optimization problem where the decisions of container allocations and frequency influence each other. The fewer containers allocated, the more frequent shipments are required and vice versa. This optimization problem is a non-linear programming problem due to the non-linear relationship between frequency and inventory level, which is substantially complex to model and develop.

The Stowage strategy covers all transportation modes and optimizes the loading configuration of parts that are to be loaded into a specific vehicle or container. The objective function is to maximize the space utilization of trailers, containers, or rail cars.

The problem is a multi-dimensional loading problem. The strategy considers all pertinent constraints such as:

Dimension of trailer or container

Dimension of racks/containers to load

Permissible orientation of racks/containers

Stackability of racks/containers

The strategy provides a graphic display of the solution to visually depict the loading. The user can zoom in and out and view from different perspectives. The user is allowed to interactively modify the solution if necessary. The functionality of the strategy is similar to standard cubing packages known in the prior art, like ALS. Overall Data Flow is summarized as follows:

Inputs

Vehicle program related elements

Parts weekly demand

Inventory level requirements

Frequency limits

Logistics elements

Sourcing

Ship Points

Docking Capacities

Potential intermediate facilities

Cost Elements

Conveyance cost—freight cost

Inventory carrying cost

Unloading cost (indirect labor)

Intermediate facilities costs

Container cost

Cubing elements

Types of trucks, rail, containers, etc.

Part sizes and weights, packaging information

Parts grouping, compatibility, and

stackability

Outputs

Cost

Freight costs and cost variance (with comparator model)

Inventory cost and cost variances

Container costs and cost variances

Repack and repack material costs and cost variances

Intermediate facilities costs and cost variances

Unloading costs and plant impact costs

Logistics plan

Mode/carriers/conveyance selection

Delivery methodology: point-to-point, milk run, cross dock

Frequency and time of pickup and delivery

Optimal number of returnable containers

Mode/frequency/conveyance for returnable containers

Optimal routing for each truck for each week day

Optimal cross dock operation

Plant material reception location

Stowage

TAPSIL Module 14 can transmit information to Supply Chain Designer Module 12 about the details of how a facility is used. For instance, if the Supply Chain Designer Module 12 provided a cross dock or ODC in Ohio as part of its design and TAPSIL Module 14 has determined that the volume does not exist to keep an Ohio facility open, TAPSIL Module 14 transmits this information to Supply Chain Designer Module 12. The information is used to effectively produce future supply chain designs.

TAPSIL Module 14 can transmit logistics plan information for at least one logistics plan to Data Warehouse Module 18. The logistics plan information can include, but is not limited to, a supplier for supplying a part and a plant for receiving a part, an at least one start location and at least one end location for shipment of the part, a transportation mode for transporting the part from the supplier to the plant, a delivery method for the transportation mode, and part delivery schedule which can include, but is not limited to, frequency, delivery time, and pickup time.

LLP Module 22 can include a Logistics Management System for managing and tracking daily implementation of the logistics plan developed by the TAPSIL Module 14, including the routes and execution of the Supply Chain Designer Module 12. This information can be referred to as operating information, which can be transmitted to Data Warehouse 18 through TAPSIL Module 14. The Logistics Management System also can resolve the exceptions in the established supply chain plan. For example, if a highway along the normal route is unusable, the Logistics Management System can make alterations to the plan. For instance, the time when a truck can arrive at the plant may be amended. As a further example, the system can identify pick ups that do not need to occur if, for instance, an assembly line is down in a plant.

Logistics Management System of LLP Module 22 can receive route plan information (including costs associated with each route) transmitted from TAPSIL Module 14. For each route, the information includes how the part will be shipped, what quantity will be shipped, how often will it be shipped, and how the returnable container will be returned.

Logistics Management System of LLP Module 22 can transmit information from the LLPs on existing performance metrics (such as cost, quality, and speed) from plants, carriers, suppliers, ODCs and LLPs to Data Warehouse Module 18.

After a part or a vehicle is delivered whether by ship, truck, rail or other transportation mode and proof of delivery is obtained, bill payment occurs, assisted preferably by Bill Payment Module 26. After establishing that the part or vehicle was satisfactorily delivered, the First Bill Payment Module 26 can verify the delivery and the accuracy of the bill then automatically pay the vendor. First Bill Payment Module 26 can transmit billing information regarding what amount was actually paid and what invoices were not paid to Data Warehouse Module 18.

The Data Warehouse Module 18 stores logistics information, including but not limited to, logistics plan information, procurement information, operating information and billing information, in one central location. Thus, those responsible for First Bill Payment Module 26 can act consistently with those responsible for Logistics Management System on LLP Module 22. Data Warehouse Module 18 can transmit information regarding the subject of payment and what has resulted from a contract to First Bill Payment Module 26. Data Warehouse Module 18 can also send this information to LLPs.

TAPSIL Module 14 can transmit information to Data Warehouse 18. The information can include, but is not limited to, route plans. Data Warehouse Module 18 can transmit information to TAPSIL Module 14, such as the number of parts needed, the size of packaging, the location of the shipment, and the contracted rates. Essentially, this information is the base data utilized by TAPSIL Module 14 to create the shipment route for a part.

Not only does Data Warehouse Module 18 store logistics information, information can be transmitted from Data Warehouse Module 18 to other modules. For example, First Bill Payment Module 26 needs information regarding contracts in existence according to Procurement Module 30 (described more fully below). For example, if the manufacturer had a contract with a transportation provider to ship parts at a rate of $200 on a particular line, First Bill Payment Module 26 uses procurement information to monitor whether the parts were actually delivered and whether the invoice was for the amount of $200. In addition, Data Warehouse Module 18 can store information on these actual costs of transportation because the information could affect other modules. By way of example, Supply Chain Designer Module 12 monitors whether bills from a particular transportation line were higher than anticipated because of valid exceptions to the contracted amount. From a management perspective, Procurement Module 30 would need to know that the manufacturer has paid $400 instead of $200 because of valid exceptions to a contracted amount. Supply Chain Designer Module 12 can reevaluate whether it is economical to use that line. By way of further example, First Bill Payment Module 26 can transmit information to the Data Warehouse Module 18 on the number of outstanding invoices. Data Warehouse Module 18 can transmit information on issues such as where suppliers are located and where the manufacturer is requesting carriers to various modules.

LLP Module 32 can include a Second Bill Payment System, which has essentially the same functionality as First Bill Payment Module 26, but applied to LLPs. Second Bill Payment System can determine the following values: account freight, LLP fees and payment associated with ODCs. For example, some LLPs pay the bills for truckers that are bringing material into an ODC. Nevertheless, these costs are eventually passed onto the manufacturer, which pays the LLP by way of a contract. Second Bill Payment System of LLP Module 32 can transmit information regarding amounts paid by the LLP for contracts to Data Warehouse Module 18.

Preferably, Data Warehouse 18 includes Cost Control Sub-Module 36 which analyzes and monitors the overall performance and administration of the global, integrated logistics system. For example, Cost Control Sub-Module 36 has access to what manufacturing is paying for various aspects of the supply chain, whether the costs have been met, and quality metrics. Cost Control Module 36 can also monitor performance by the manufacturers and LLPs.

TAPSIL Module 14 can transmit the designed logistics network, product program and the proposed cost to Cost Control Sub-Module 36. Throughout the production process, Cost Control Sub-Module 36 can transmit the budget and the actual costs of the production to TAPSIL Module 14. By way of example, if TAPSIL Module 14 sent Cost Control Sub-Module 36 a budget stating that a part would cost $50 a vehicle, Cost Control Sub-Module 26 transmits information to TAPSIL Module 14 that the actual cost was $40 a vehicle. Thus, TAPSIL Module 14 may use the information within the TAPSIL Module 14 when creating the next design. It is part of a feedback process.

First Bill Payment Module 26 and Second Bill Payment System of LLP Module 32 can transmit bill payment information (i.e., determination that a bill must be paid and paid the bill) to Cost Control Sub-Module 36.

Once the Supply Chain Designer Module 12 has a supply chain design in place, Procurement Module 30 procures the transportation for the supply chain. According to the present invention, the entire production purchasing can be performed by one electronic package. By using one system, there will be more notification of changes in the production purchasing of parts from suppliers that might affect the logistics network. Additional information important to Procurement Module 30, including but not limited to information on core carriers, strategies, center box, and market testing, can be automated by the Procurement Module 30. Moreover, the contracts and rates available through Procurement Module 30 can be transmitted to logistics users. Procurement Module 30 can transmit information to the Data Warehouse Module 18 through transition line 36 about what the manufacturer purchased, what carriers the manufacturer is going to use, and at what rates.

TAPSIL Module 14 can transmit a request to Procurement Module 30 for quotes from carriers on rates for a particular design that TAPSIL Module 14 is developing. Procurement Module 30 can transmit the requested information back to TAPSIL Module 14.

Procurement Module 30 can transmit information about its contracts and rates to Cost Control Sub-Module 36 for budget purposes. In return, Cost Control Sub-Module 26 can provide budget information and budget objectives to Procurement Module 30. By way of example, if the budget for a given year is $100,000,000 and the next year the budget will be $95,000,000, Cost Control Sub-Module 36 transmits this information to Procurement Module 30 for contracting purposes.

LLP Module 38 can include a Transportation Manager System for managing everyday changes in the transportation system. By way of example, the Transportation Manager System can identify if a regular pick up at a supplier is unnecessary on a particular day and can determine whether the truck could make a different pick up on its “milk run” so that the truck space would not be wasted. Transportation Manager System can determine whether an additional truck or delivery is necessary on a particular day. Through dynamic routing, the Transportation Manager System can protect the savings made through this supply chain design.

Information can be shared between Procurement Module 30 and the Transportation Manager System. By way of example, the procurement of trucks not originally provided for in the contracts, i.e., exceptions to the established contract, still require contracts. Further, the contracts must be consistent with strategies established for purchasing transportation. Thus, Procurement Module 30 communicates this information such as strategies, contracts with carriers, rates and lists of carriers from which Procurement Module 30 authorize the Transportation Manager System to purchase services. The Transportation Manager System provides information on services purchased and the need to purchase additional services.

LLP module 32 can include a Nirvana Cost Control System has purpose similar to the Cost Control Sub-Module 36, but it only relates to the costs of the LLPs. Nirvana is used to describe the outsourcing of an inbound logistics network to an LLP. Like Cost Control Sub-Module 36, the Nirvana Cost Control System must know what the LLP is paying for various aspects of the supply chain, whether the costs have been met, and the quality metrics. Nirvana Cost Control System can also monitor the performance, center box and administration of the LLPs. Nirvana Cost Control System can transmit information on costs and metrics to the Cost Control Sub-Module 36. This information can be used for overall cost control.

According to a preferred system of the present invention, logic is applied to at least a portion of the information stored in the Data Warehouse Module to obtain logistics information grouping(s) relied upon by logistics users to manage at least one logistics initiative. The present invention realizes that the information stored within the Data Warehouse Module originates from a variety of sources, i.e, manufacturers' systems applications, LLP applications, and computer files. It should be understood that manufacturers' systems applications can include, but are not limited to, inventory management systems as well as logistic systems. Consequently, logic is applied to this raw, diverse information to transform it into logistics information grouping(s) that can be relied upon by logistics users. For example, a logistics information grouping can be provided for inbound material logistics (“IML”) accrual overview. This grouping can include, but is not limited to, an integrated view of the expected freight charges and actual freight payments by mode, plant, supplier, and month. This grouping of information can be relied upon by logistics and finance managers to manage logistics initiatives with respect to budget and outstanding liability. As another example, a logistics information grouping can be provided for IML Payments. This grouping can include, but is not limited to, an integrated view of the freight bill, payment voucher, and check for manufacturing and assembly supply chains. Preferably, the information in this grouping is provided by LLP(s). This grouping of information can be relied upon by logistics and finance managers to manage logistics initiatives with respect to budget performance and as feedback to logistics planning applications.

Preferably, the logistics information grouping(s) can be utilized by logistics users through Logistics User Module 44. The logistics information grouping(s) can be displayed to logistics user(s) through Logistics User Module 44. The logistics user can also generate logistics reports by using Logistics User Module 44 and the logistics information grouping(s). Preferably, Logistics User Module 44 can be implemented using software products available from Business Objects America, Inc. of San Jose, Calif. For example, Business Object's WebIntelligence (“WebI”) software product can be used to allow the logistics user to review logistics information grouping(s) and generate logistics reports.

For example, the controller's office, and other logistics users, can utilize the IML accrual overview information grouping and WebI to generate accrual reconciliation reports.

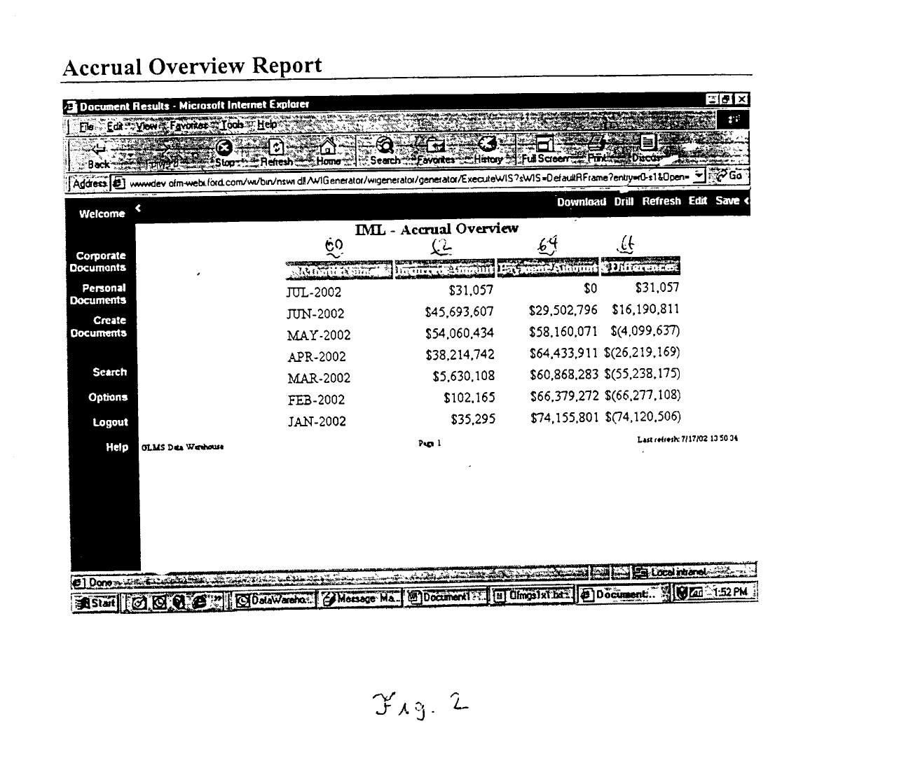

FIG. 2 illustrates a preferred GUI for displaying an IML accrual overview report. Preferably, the logistics user is prompted to select a year for report generation. According to FIG. 2, the logistics user selected 2002. The IML accrual overview report can include but is not limited to, the following information for the selected year: month 60, incurred amount 62, payment amount 64, and difference 66.

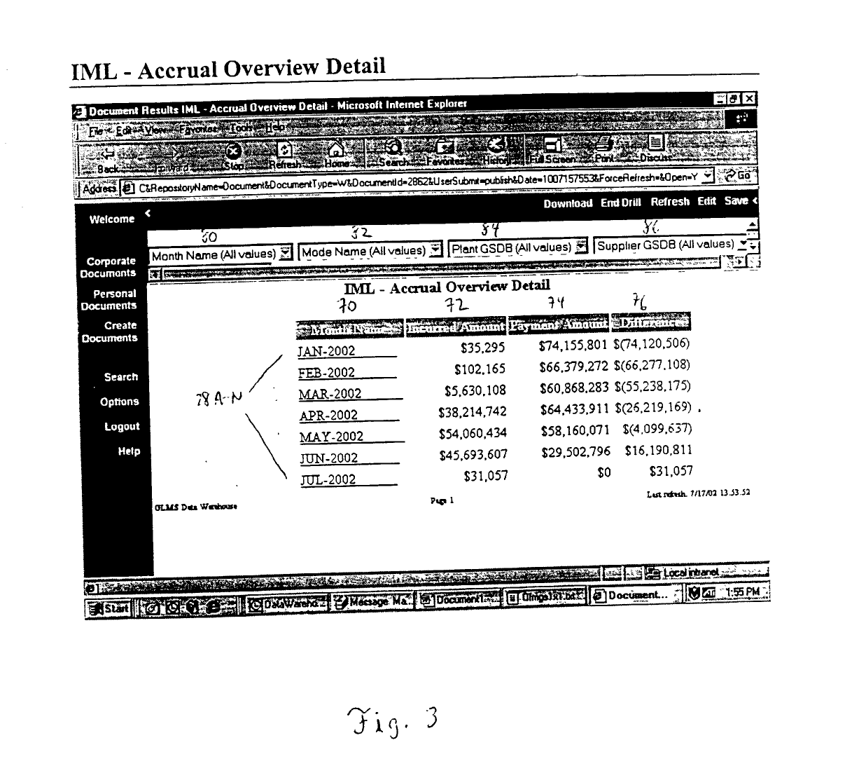

FIG. 3 illustrates a preferred GUI for displaying and entering information pertinent to an IML accrual overview detail report. The IML accrual overview report can include, but is not limited to, the following information for the selected year: month 70, incurred amount 72, payment amount 74, and difference 76. This report is similar to the accrual overview report, except that the logistics user has the ability to drill into the information presented by the report by month, mode, plant, and/or supplier by clicking on one of the hypertext month links 78A-N. Logistics users can also filter the information contained in the IML accrual overview report by selecting values (one at a time) from the following drop down lists: month name 80, mode name 82, plant GSDB 84, and Supplier GSDB 86.

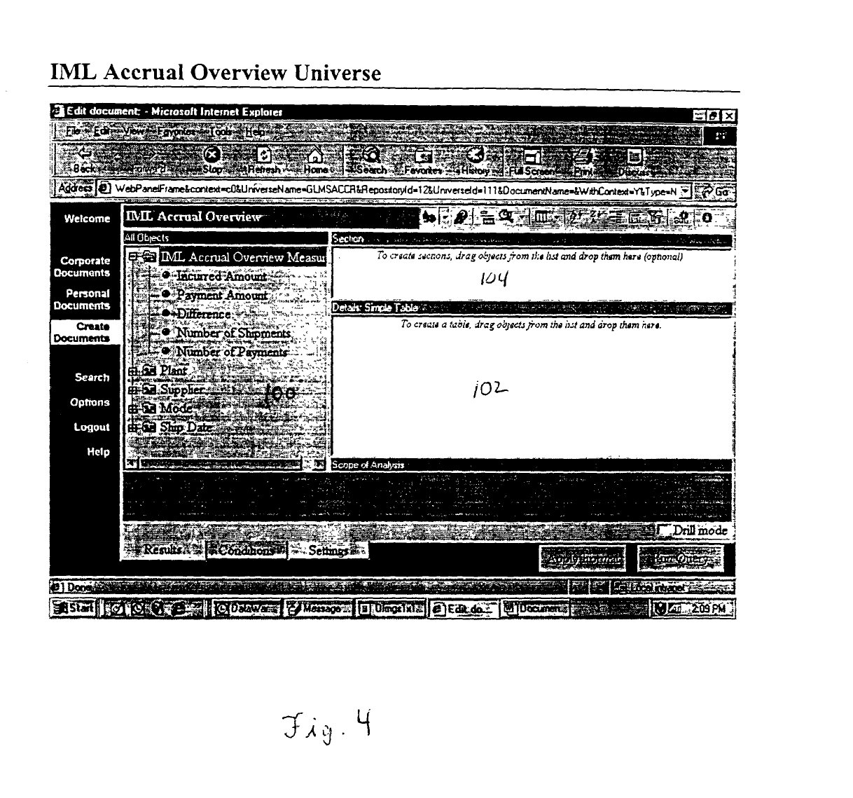

FIG. 4 illustrates a preferred GUI for entering information for generating a customized accrual reconciliation report. Data elements that can be generated as part of the customer report include, but are not limited to, incurred amount (sum of contract rate from the shipment table), payment amount (sum of voucher amount from the voucher table), difference (difference between incurred and payments), number of shipments (count of the shipment transactions for the month), number of payments (count of the payment transactions for the month), plant (plant global supplier database (“GSDB”) and other plant information), supplier (supplier GSDB and other plant information), ship date (ship month, quarter, and year), and mode and sub mode (sub mode name and mode name). To create a report table, logistics users can drag objects from the objects list 100 to the simple table box 102. Optionally, logistics users can drag objects from the objects list 100 and drop then in the section box 104 to create sections.

The user can also generate an IML detail accrual report, which is the transaction detail of a set of shipments, freight bills, vouchers, and payments for a particular supplier, plant, mode, and month, selected by the logistics user. Preferably, the report is arranged so that all of the shipments and the matching freight bills, vouchers, and checks are contained on the report.

It should be understood by an individual of ordinary skill in the art that reports can be generated for other logistics information groupings even though examples of such reports are not disclosed herein.

While the best mode for carrying out the invention has been described in detail, those familiar with the art to which this invention relates will recognize various alternative designs and embodiments for practicing the invention as defined by the following claims.

What is claimed:

1. A computer-implemented system for managing logistics for manufacturing and assembly supply chains comprised of a plurality of suppliers, a plurality of plants, a plurality of parts, and a plurality of transportation modes, the computer-implemented system comprising at least one computer configured to:
receive logistics information;
store logistics information in a data warehouse contained on the at least one computer;
apply logic to at least a portion of the logistics information stored in the data warehouse to obtain at least one logistics information grouping relied upon by logistics users to manage at least one logistics initiative.

2. The computer-implemented system of claim 1 wherein the logistics information includes logistics plan information, procurement information, operating information, and billing information.

3. The computer-implemented system of claim 2 wherein the logistics plan information includes a supplier for supplying a part and a plant for receiving the part, an at least one start location and an at least one end location for shipment of the part, a transportation mode for transporting the part from the supplier to the plant, a delivery method for the transportation mode, and part delivery schedule which includes frequency, delivery time, and pickup time.

4. The computer-implemented system of claim 3 wherein the procurement information includes procurement contract information and procurement billing rates.

5. The computer-implemented system of claim 4 wherein the operating information includes information regarding the implementation of the logistics plan.

6. The computer-implemented system of claim 5 wherein the billing information includes information from the supplier regarding actual shipment of the part.

7. The computer-implemented system of claim 6 wherein the logistics user is the controller's office and the logistics initiative is accrual reconciliation.

8. The computer-implemented system of claim 7 wherein the at least one computer is additionally configured to generate at least one logistics report based on the at least one logistics information grouping.

9. The computer-implemented system of claim 8 wherein the at least one logistics report is an IML accrual overview detail report.

10. A computer-implemented method for managing logistics for manufacturing and assembly supply chains comprised of a plurality of suppliers, a plurality of plants, a plurality of parts, and a plurality of transportation modes, the computer-implemented method comprising:
receiving logistics information;
storing logistics information in a data warehouse contained on at least one computer;
applying logic to at least a portion of the logistics information stored in the data warehouse to obtain at least one logistics information grouping relied upon by logistics users to manage at least one logistics initiative.

11. The computer-implemented method of claim 10 wherein the logistics information includes logistics plan information, procurement information, operating information, and billing information.

12. The computer-implemented method of claim 11 wherein the logistics plan information includes a supplier for supplying a part and a plant for receiving the part, an at least one start location and an at least one end location for shipment of the part, a transportation mode for transporting the part from the supplier to the plant, a delivery method for the transportation mode, and part delivery schedule which includes frequency, delivery time, and pickup time.

13. The computer-implemented method of claim 12 wherein the procurement information includes procurement contract information and procurement billing rates.

14. The computer-implemented method of claim 13 wherein the operating information includes information regarding the implementation of the logistics plan.

15. The computer-implemented method of claim 14 wherein the billing information includes information from the supplier regarding actual shipment of the part.

16. The computer-implemented method of claim 15 wherein the logistics user is the controller's office and the logistics initiative is accrual reconciliation.

17. The computer-implemented method of claim 16 further comprising generating at least one logistics report based on the at least one logistics information grouping.

18. The computer-implemented method of claim 17 wherein the at least one logistics report is an IML accrual overview detail report.

19. A computer-implemented system for determining an inbound logistics plan, the system comprising at least one computer, the at least one computer configured to:
store a plurality of supplier/plant/part combinations, each supplier/plant/part combination having a plurality of transportation modes and frequencies for transporting material from the supplier to the plant;
determine a preferred supplier/plant combination with a preferred transportation mode and frequency for each supplier/plant/part combination which delivers minimum costs for transporting material from the supplier to the plant while respecting operating requirements, the transportation costs calculated based on the transportation mode, transportation frequency, inventory and container costs; and
use the preferred supplier/plant/part combination with the preferred transportation mode and frequency as part of the inbound logistics plan to minimize inventory, material and rack costs.

20. The computer-implemented system of claim 19 wherein the at the at least one computer is further configured to determine a returnable container flow strategy that minimizes container costs while minimizing inventory, material, and rack costs.

21. The computer-implemented system of claim 19 wherein the at least one server computer is further configured to determine a stowage strategy while respecting restriction regarding stacking constraints, weight distribution, and pickup and delivery sequences.

22. The computer-implemented system of claim 19 wherein the preferred transportation mode is the truck mode.

23. The computer-implemented system of claim 22 wherein the at least one computer is further configured to determine a rotation and routing strategy by minimizing travel inventory and rack costs while respecting dock capacities and window time availabilities and balancing in-plant inventory levels.
